(19) United States
(12) Patent Application Publication
(10) Pub. No.: US 2012/0087792 A1
(43) Pub. Date: Apr. 12, 2012

(54) EMERGENCY FEATHER RATE LIMIT WITH PROPORTIONALITY TO OPERATING PITCH ANGLE AND ENERGY STORAGE VOLTAGE

(75) Inventors: Kevin L. Cousineau, Lompoc, CA (US); Sandeep Gupta, Ventura, CA (US); Cole Clayton Rogers, Carpinteria, CA (US)

(73) Assignee: Clipper Windpower, Inc.

(21) Appl. No.: 12/902,506

(22) Filed: Oct. 12, 2010

(51) Int. Cl. F03D 7/00

(52) U.S. Cl. 416/1; 416/151

(57) ABSTRACT

A system and method are disclosed for an emergency feathering control of a wind turbine during emergency feathering of the turbine blades that is independent of a turbine control and pitch control unit. A variable pitch rate controller generates commands to drive an AC servo motor for blade feathering. A first pitch rate is obtained with a back-up storage unit, such as a super capacitor. The commands from the controller vary the pitch rate of the blades during feathering in an emergency to a second pitch rate that is different from the first pitch rate.

### FIELD

The present disclosure relates to energy producing devices and related safety systems and methods. While the disclosure is particularly directed to wind turbines and will thus be described with specific reference thereto, it will be appreciated that the disclosure may have usefulness in other fields and applications, particularly those involving energy producing devices.

### BACKGROUND

Wind turbines drive synchronous or asynchronous generators to produce electrical power and may include systems for feathering the turbine's blades when it is desired to shut the turbine down. One condition requiring such blade feathering is excessive wind velocity, for example, in the event of strong wind velocities that could exceed the turbine's rated loads on the blades, nacelle, tower or other components. To achieve such feathering, the pitch angle of the blades is adjusted to approximately 90° whereupon wind flow over the blades fails to produce any torque, which would otherwise cause rotation of the blades and therefore rotation of the generator rotor.

Safety systems in a turbine include stored energy sources that enable the feathering to occur after a loss of power or loss of the main control system itself. Entry into a safe position is achieved when a safety loop of the safety system becomes open. The pitch system changes the blade position and pitches it back to its feathered position. This process is known as Emergency Feather Control (EFC). To minimize operating time at overspeed conditions, rapid blade feathering is desirable. However, feathering at a constant, rapid rate could result in excessive blade stresses due to substantial decelerating (negative) torque and reverse thrust developed by the blades as they approach completely feathered positions.

As the size of Utility Grade wind turbines grows, the requirements for the pitch system grow with them. Accordingly, a need has arisen to provide safety systems that effectively control pitch while minimizing the decelerating torque and reverse thrust developed by the blades, and thus, minimize stresses, such as load stresses.

### SUMMARY

The following presents a simplified summary in order to provide a basic understanding of one or more aspects of the disclosure. This summary is not an extensive overview, and is neither intended to identify key or critical elements, nor to delineate the scope thereof. Rather, the primary purpose of the summary is to present some concepts of the disclosure in a simplified form as a prelude to the more detailed description that is presented later.

In one embodiment, an energy producing device safety system controls an emergency feathering of blades during an emergency power shut down of the energy producing device. The system includes an energy storage unit for operating the safety system independently of a control unit during the emergency power shut down of the device. A servo motor is electrically coupled to a servo drive amplifier circuit supplied with power from the energy storage unit for rotating the blades. A variable pitch rate controller is coupled to the energy storage unit and the servo drive circuit that is configured to vary a pitch rate of the blades from a first pitch rate to a second pitch rate based on a blade angle position of the blades during the emergency feathering. The variable pitch rate controller is configured to provide variable pitch rate commands to the servo drive circuit, and in response, the servo drive circuit provides a first set of motor signals and a second set of motor signals to the motor corresponding to the first pitch rate and the second pitch rate commands respectively.

In another embodiment, a method is disclosed for controlling an emergency feathering of blades during an emergency power shut down of an energy producing device with a safety system. A variable pitch rate controller receives a current from an energy storage unit. The safety system has a safety circuit loop that initiates blade feathering independently of a control unit and a pitch system control. The variable pitch rate controller transmits a first set of command signals to a servo amplifier, which then generating an alternating current signal for an AC servo motor to operate at a first pitch rate. The variable pitch rate controller therefore causes one or more blades with the servo motor to rotate at the first pitch rate for a first duration of time that is based on a pitch angle position during the emergency feathering. The first pitch rate is varied to a second pitch rate with a second set of command signals for a second duration of time.

The following description and annexed drawings set forth in detail certain illustrative aspects and implementations of the disclosure. These are indicative of only a few of the various ways in which the principles of the disclosure may be employed.

### BRIEF DESCRIPTION OF THE DRAWINGS

FIG. 1 illustrates a block diagram of a typical wind turbine electrical/control system including the safety system in accordance with one aspect of the present disclosure;

FIG. 2 illustrates a schematic view of a wind turbine Pitch Control Unit (PCU) or pitch system and its associated safety system in accordance with another aspect of the present disclosure;

FIG. 3 illustrates a graph comparing fixed pitch rates and variable pitch rates during an emergency feathering; and

FIG. 4 illustrates an exemplary method for a safety system to monitor safety of a wind turbine in accordance with another aspect of the present disclosure.

### DETAILED DESCRIPTION

One or more implementations of the present disclosure will now be described with reference to the attached drawings, wherein like reference numerals are used to refer to like elements throughout.

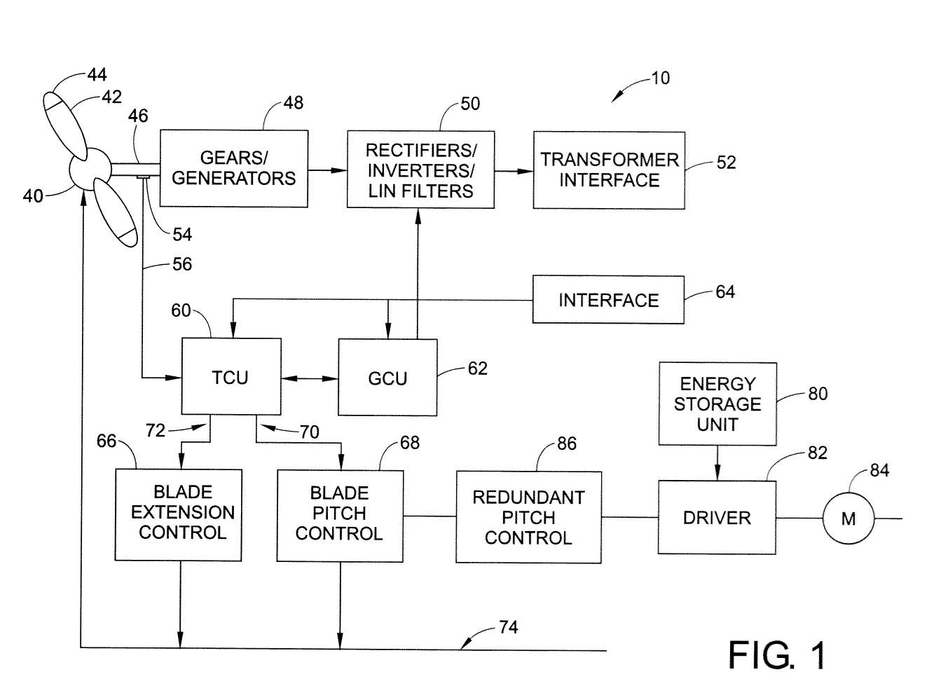

Referring to FIG. 1, shown is a block diagram of a typical wind turbine electrical control and safety system 10 that has a variable pitch angle safety system and an energy storage unit for emergency feathering. While the form of energy producing device discussed herein will be a wind turbine, it should be appreciated that the energy producing device could also be an ocean current turbine or the like. The system 10 comprises a turbine drive train that includes a rotor hub-mounted pitch system 40, a blade rotor that includes a root blade 42 and an extender blade 44, a gearbox and a generator 48 (e.g., a permanent magnet generator (PMG)), and a generator rectifier/inverter unit 50. The system 10 further includes a control system comprising a turbine control unit (TCU) 60, a generator control unit (GCU) 62, a pad-mount transformer 52, and an interface 64 connecting the control system to a utility grid.

The system 10 includes one or more rotor blades 42, 44 that are connected via a rotor hub mounted pitch-angle servo, for example, which is powered through slip rings via blade drive signal bus 74. The hub 40 is mechanically connected to a turbine main-shaft 46, which transmits the turbine's torque to a gearbox 48. A sensor for measuring turbine speed 54 may be located on the low speed shaft, the output of which is the shaft speed 56. The turbine shaft is coupled via gears and generator 48 and a suitable coupling device to, in this example, a permanent magnet, wound field synchronous generator or induction generator can be used.

In this embodiment, the generator electrical output is connected to the rectifier, inverter, and line filter unit 50. The rectifiers are operable as converters that convert the electrical power to DC voltage and a current on a DC bus (not shown). The DC bus is connected to a wind turbine generator (WTG) inverter, for example. The inverter regulates the DC current and by doing so, the generator torque is controlled. The inverter regulates this DC current by synchronizing to the grid and by supplying unity power factor current into the grid system. The control of the inverter (within block 50) is provided by a generator control unit (GCU) 62. The GCU takes inputs such as grid voltage, DC bus voltage, grid current load power demand I (demand in) from its own measurements and receives commands such as torque level from the TCU 60. The AC grid voltage measurement and current measurement are obtained from the output of the rectifiers, inverters, and line filters 50 and these measurements are used by the GCU for purposes of synchronizing the inverters to the AC grid. The converter takes the input voltage and current signals and can convert these into pulse-width-modulated (PWM) signals, which tell a switch in the inverter 50 when to turn on and off. These switches are controlled in such a way as to maintain regulated AC output current in response to the current command supplied by the TCU. Line filters on the inverter output are used to reduce any harmonics that may have been generated by the inverter before passing power to a pad-mount transformer 52 on the utility grid.

The TCU 60 can further receive sensor information provided by sensor inputs. The information may include, for example, turbine speed, blade pitch angle, tower acceleration (vibration), nacelle acceleration (nacelle vibration), wind speed, wind direction, wind turbulence, nacelle position, AC line parameters, DC bus voltage, generator voltage, power output, and/or other sensor information, which may also be generated within a safety loop circuit for fault related sensing. The TCU 60 has control of the principal actuators on the turbine, the generators via the GCU 62, the pitch unit (PCU) 68 and the Blade Extension Control Unit (ECU) 66. The Turbine Control Unit (TCU) 60 sends the proper generator torque required as a signal to the Generator Control Unit (GCU) 62. In high winds, the turbine remains at a constant average output power through a constant torque command from TCU and a constant speed command to the PCU.

The control system governs the variable rotor radius (via blade extension/retraction), a pitch of the rotor blades, and the rotational rate of the rotor, for example. The TCU 60 determines a pitch angle for the blades by means of an algorithm or lookup tables. A blade pitch command 70 is sent from the TCU 60 to the Blade Pitch Control Unit (PCU) 66, which generates blade rotation drive signals that pass over bus 74 to each of three servo motors that turn their respective blades.

In the event of an emergency feathering routine of the turbine blades, pitch system power is switched or is derived automatically from a backup power energy storage unit 80 is operable for providing power to a controller or driver 82 for driving each servo motor, such as servo motor 84. A redundant pitch control 86 operates as a variable pitch rate controller for sending commands to the driver 82. The energy storage unit 80 may comprise a super capacitor, ultra-capacitor, capacitor, battery, flywheel, or a compressed air accumulator or other means of DC energy storage that provides power to operate feathering of the blades as a redundant safety system independently of the TCU 60 and the PCU 66. For example, power from the energy storage unit is connected from the energy storage unit 80 to the driver 82 and redundant pitch control 86 during an emergency power shut down and feathering of the blades. The blades are feathered rapidly at a first pitch rate to slow the blades down enough to prevent the generation of power by the turbine. Once the blades reach a certain angle and/or are pitched for a predetermined time duration, the pitch rate is varied to a second pitch rate that is slower. Finally, blades are pitched at a pitch rate of zero afterwards once the blades are at a fully feathered position. This allows for redundancy in the safety system as well as backup control and a reduction of load, and prevents any further increase in rotor speed on the turbine.

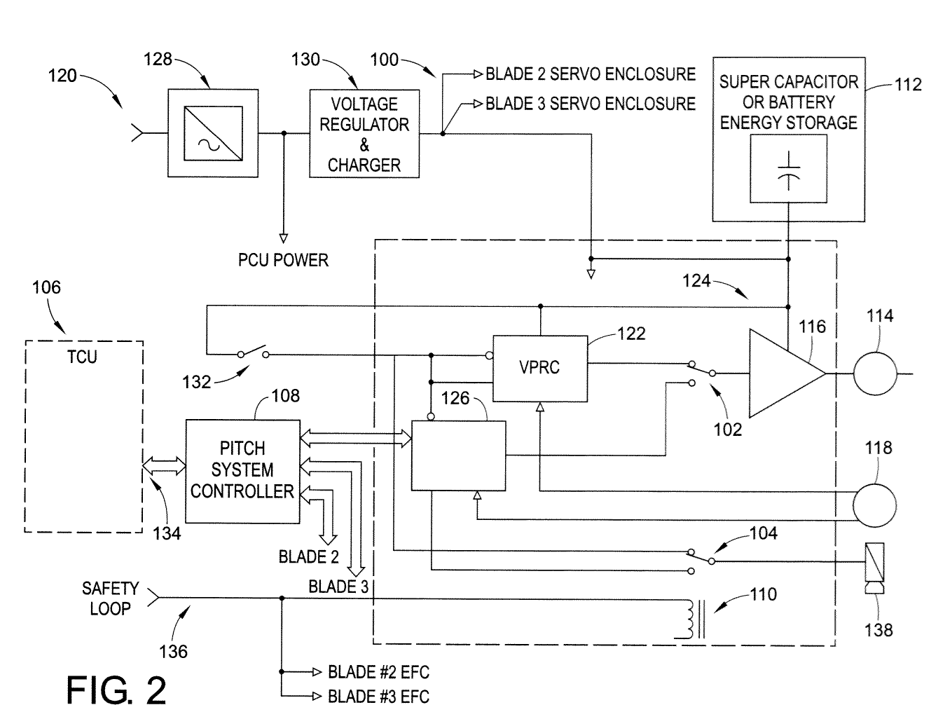

Referring now to FIG. 2, an example of a wind turbine variable pitch control system and integrated safety system 100 is there illustrated. With the safety system 100 powered (no safety issues with the turbine), relay switch 102 (e.g., K1a) and relay switch 104 (e.g., K1b) are in their servo position (a down position, not shown) and commands from a wind turbine controller (e.g., TCU 106) are received into a blade pitch system controller 108, such as for a control loop therein, for example.

During an emergency reaction and/or a loss of power, the safety system relay 110 drops out and its contacts move to the position shown in FIG. 2 (up). The pitch motors will begin operating using an energy storage unit 112, which can comprise a super capacitor and/or a battery supply or other energy storage systems. This causes the motors to pitch the turbine blades from their operating pitch position to a “feathered” or 90 degree position. In this position the turbine is “safe” as the RPM of the rotor is reduced to less than 1 RPM in even the highest of wind conditions. Once the fault is cleared, or power is returned, the safety loop may be reset and operation of the turbine can began again, allowing the TCU to command the blade to the required positions for proper operation of the turbine.

The wind turbine variable pitch safety system 100 can comprise an AC motor 114 and an AC motor servo amplifier (drive) 116 along with energy storage unit 112, which may be a super capacitor, for example. The AC motor 114 is used to drive the blade pitch gearbox which, in turn, drives a blade pitch bearing (not shown) and moves the blade into its required position. In addition, a motor mounted, multi-turn, absolute position encoder 118 may be used to determine the actual pitch angle of the blade.

A three-phase AC power line 120 is obtained from the turbine nacelle through a set of slip rings to the rotating hub (not shown). The three-phase power line 120 from the slip-ring assembly (not shown) is coupled to charge the energy storage unit 112, which supplies power to the servo amplifier 116 under the control of a redundant variable pitch rate controller (VPRC) 122. The energy storage unit 112 may be a storage device made up of electrochemical double layer capacitors, known as supercapacitors and ultracapacitors. Additionally, batteries, or hybrid energy storage devices, for example a combination of a battery and a super capacitor, or a flywheel or a compressed air accumulator are other examples of devices that can be used for DC power energy storage. The power from the slip-ring assembly is used to charge the super capacitor or battery as shown, which is used as a backup for blade pitch control functions in the event of a loss of power, such as during an emergency feathering response. Once the blades are in a fully feathered position (e.g., ninety degrees with respect to the initial position) the energy storage unit 112 is switched out by the feather limit switch 132 that is activated by the blade itself as it passes into its 90 degree position.

The level of capacitance in the energy storage unit 112 is directly proportional to its voltage and is monitored by the variable pitch rate controller 122 via a DC input line 124 (e.g., a DC bus). The voltage regulator and charger 130 can regulate the charging of the energy storage unit 112 during initial application of power to the three phase rectifier and filter system 128. The three-phase AC power is rectified by the rectifier and filter block 128, with rectifiers used to provide the DC voltage necessary for the super capacitor or battery and controlled by the charge controller/voltage regulator 130. This energy is supplied to the servo amplifier 116 and DC input line 124. For a typical application, the charge current could be set to 50 or 75 amperes. A charge time would depend upon the size of the capacitor bank. For example, with a bank of 26 Farad and a charge current of 75 amperes, the charge time to 250 volts could be less than 2 minutes at that constant current rate

Under non-emergency operation when the safety loop is “closed” and there is no need for emergency feathering, overall system control is provided by the pitch system controller 108 and a pitch command controller 126, which together are used to overall motor position control, and a pitch command controller 126 for the servo motor commands and alarm monitoring. In addition, the pitch system controller 108 communicates with the Turbine Control Unit 106 via a slip ring communications interface 134 to obtain the proper pitch angle required for operation and to communicate all motor and controller status and alarm states. The pitch system controller 108 may communicate with the Turbine Control Unit processor indicating the absence of alarms and the closure of its safety system. The TCU 106 processor generally commands a pitch setting that allows the blades of the turbine to pitch to an angle that enables the turbine to begin to accelerate whereby the turbine can generate power when a proper speed is achieved. For safety purposes, the servo amplifier 116 can be turned on and used to operate the AC servo motor 114 directly from a safety loop interface line 136, without input from the pitch system controller 108. Similarly, if the pitch system controller fails, a watch dog timer output will open the safety loop, and by doing so, the motor will be driven by the servo amplifier, using the energy stored in the DC input line 124 by the super capacitors to move the blades to their emergency feathered or 90 degree pitch position.

During high winds, the turbine unit will command a pitch set point that is less than zero degrees in order to control speed or power output of the turbine. This is usually a speed regulation system and usually operates at a 20 or 30 Hz rate. The blades can be given new pitch position and pitch velocity-commands 20 or 30 times per second in order to maintain the proper speed of the rotor, which is generated with the pitch command controller 126. If the turbine faults for a standard condition, the turbine control system can initiate a “normal” shut down. This means that it will command the pitch system controller 108 to continuously pitch the blades from their current operation position toward their feathered 90-degree position at a slow 1 to 4 degrees per second. At a point in time, the generator will be disconnected from the grid and once the turbine reaches its 90-degree position, it will be only rotating at a very slow (less than 1 RPM) speed at the hub.

If the turbine faults for an emergency condition (e.g., an operator pressing an emergency stop button or another emergency situation), the safety loop interface line 136 will force the servo amplifier to operate the pitch motor with the variable pitch rate controller 122. Under these circumstances, the servo amplifier will ignore commands from the pitch command controller 126 and the pitch system controller 108 because the switches 102 and 104 are repositioned. This makes the feathering safety system 100 with the variable pitch rate controller 122 operate feathering independently of a TCU and/or PCU of a turbine, with the energy storage unit 112 used as back-up power. The servo amplifier 116 pitches the motor at a variable pitch rate. Initially, a first pitch rate is high, for example, about 7 to 10 degrees per second or some other high pitch rate. Then, a second, lower, pitch rate (e.g., about 3 or 4 degrees per second) is commanded by the servo motor 114. The blades continue to rotate until the motor is stopped by variable pitch rate controller 122 and the blades on the hub assume an approximately 90-degree position. The variable pitch rate controller 122 ensures that the blades enter into the approximately 90-degree position without over run from various inputs received. For example, at least one feather limit switch 132 together with pitch angle positions from the pitch position encoder 118 are received by the variable pitch rate controller 122 and are used to determine that the 90-degree position is reached without over run. The inputs are used to determine the final 90-degree position by the variable pitch rate controller 122, which is not limited to these inputs only and also includes a brake input from a braking mechanism 138.

In one embodiment, the variable pitch rate controller 122 comprises a set of analog, and/or digital components, which generate the pitch rate required during emergency feather conditions. For example, programmable logic devices (PLD's) or analog circuit components, such as operational amplifiers can make up the controller 122. Alternatively, a microcontroller could be used. However, with PLD's or Op amps, the controller is made simple, without the need for any programming with a fast and repeatable response being implemented.

In another embodiment, pitch rate and acceleration commands originate from the variable pitch rate controller 122, which determines the optimum pitch rate for the given turbine during emergency conditions. Different sets of these commands are used to vary the pitch rate of the blades during emergency feathering. For example, the servo amplifier 116 is operatively connected to the energy storage unit 112 and the AC servo motor 114. The servo amplifier 116 drives the motor with a set of frequency and voltage signals in response to the pitch rate and acceleration commands of the controller 122 and a DC current received from the energy storage unit 112.

The variable pitch rate controller 122 determines the discharge rate of the capacitor, receiving the position of the blades from the encoder 118 and the feather rate signals from the feather limit switch 132. In response, a first and a second set of pitch rate commands are transmitted to the servo amplifier 116. In one embodiment, the amplifier 116 then causes the motor to respond to the position, acceleration, discharging of the capacitor and pitch rate commands of the controller via a first set of AC motor signals and a second set of AC motor signals respectively comprising different frequency and voltage signals. These motor signals correspond to the first pitch rate and the second pitch rate of the blades, respectively, with the discharge of the capacitor.

In one embodiment, the variable pitch rate commands include the first pitch rate that is about five to twelve degrees per second for an initial duration of time, such as a number of seconds, until the turbine no longer generates a power output. The number of seconds for the first pitch rate is about two to five seconds when the blades are pitched at a zero degree initial position, or less if the blades are pitched greater than the zero degree initial position.

A transition from a maximum and a minimum pitch rate is determined according to an exponential curve that matches the discharge of a capacitor of the energy storage unit 112. The capacitor is not completely discharged in order to leave sufficient capacity to enable a minimum pitch rate until the wind turbine blades reach their ninety degree position.

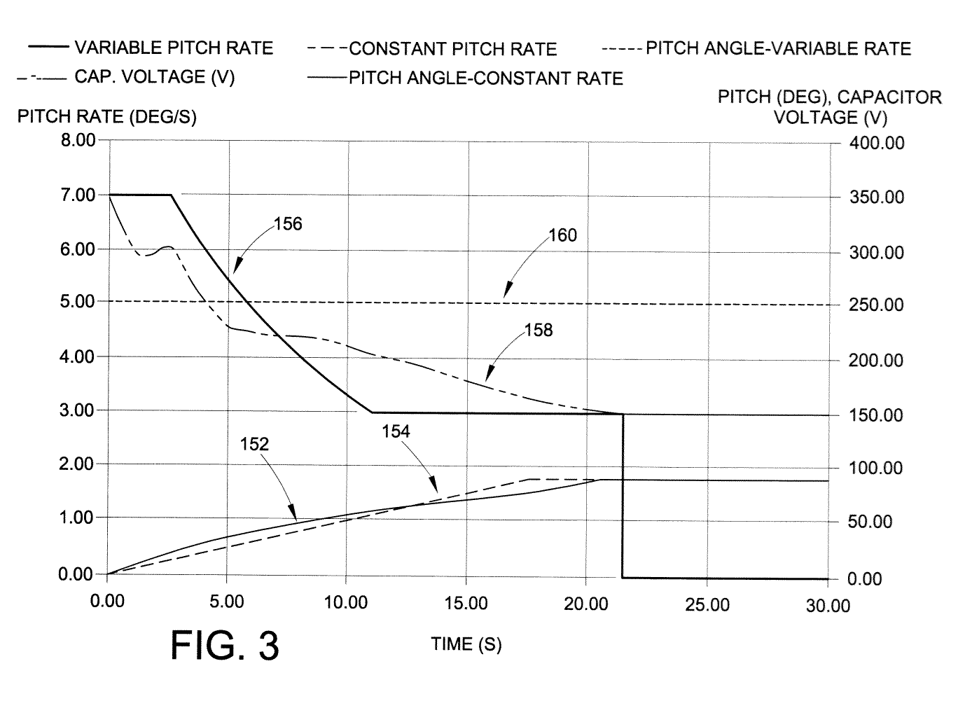

With reference now also to FIG. 3, a calculation of energy storage requirements will be discussed.

Most modern wind turbines employ motors rated at 2.5 to 10 kW. At 250 VDC, a 10 kW motor would be expected to draw 40 amperes continuously. The peak draw will be greater and the actual draw during emergency operation will also be somewhat greater. For energy storage calculations, assume a 50 ampere continuous current draw during the time the turbine is required to feather from 0 to 90 degrees. The pitch rate associated with emergency feathering is usually anywhere from 2.5 to 10 degrees per second depending upon the type of turbine. Assume a pitch rate of 7 degrees per second for the calculations.

Working with a typical 2,600 Farad, 2.7-volt capacitor, and placing 100 of these in series results in a capacitor with a value of: Total Capacitance=Individual Capacitance/# of Capacitors in Series. This equals 26 farad with a voltage rating of 2.7 volts and a peak voltage rating of 300 volts DC.

The time available at a constant current draw of 50 amperes is dependent upon how far the capacitors can be discharged. When operating with these types of systems it is apparent that a voltage drop from 250 to 150 would be acceptable while still providing a reasonable pitch rate performance. Fortunately, if the pitch rate varies, the highest pitch rate will occur during start of the emergency feather, when it is most needed, and as the blades pitch farther back toward their feather position, the rate will probably slow down. Assume that the overall, average, integrated pitch rate will be about 5 degrees per second or that the turbine will require 18 seconds to pitch from zero to 90 degrees. Based on a 100 volt drop in DC bus voltage, the time available during that drop will be: t=Capacitance×Delta V/Current=26×100/50=52 seconds.

Therefore, the required energy storage for a 26-farad capacitor is more than sufficient to assure proper emergency feather of the turbine blades. Although a smaller capacitor may be used, the change in capacitance due to aging and temperature effects must be considered. These can account for as much as a 30% change in capacitance. Under those worst-case conditions, the 26-Farad capacitor will only act like an 18-Farad capacitor and the total time available for discharge over a 100 volt delta will be: t=18×100/50=36 seconds. This is still twice the time needed, so clearly a smaller capacitor may be used in this application. These calculations are used to show how one would size a supercapacitor storage bank for operation with this type of system.

In the event of AC power loss or other emergency situations, back-up power from the energy storage unit 112 is used to feather the blades to rapidly shut down the turbine. The supercapacitor energy storage element provides sufficient power to immediately shut down the wind turbine and feather the blades by changing the pitch.

Referring to FIG. 3, a graph illustrates some differences between fixed rate pitching during an emergency feathering of wind turbine blades and a variable fixed rate pitching of the blades. For example, a pitch angle curve 152 for the variable pitch rate of the blade is advanced, over a fixed rate or constant pitch rate angle curve 154 such that at 5 seconds into the event, the pitch angle curve 152 for the variable rate is higher than the pitch angle curve 154 of the fixed rate for blade pitching. Conversely, after about 12 seconds into the event the fixed rate pitch angle is higher than the variable rate. Thus, a higher pitch rate during the first 10 seconds or so is seen for the emergency feathering event. The pitch rate as shown by the pitch angle curve 152 is afterwards slowed because there is no need to rush to the end when the loads are off of the turbine at this point. Although it takes longer for the variable rate to reach the feathered position, that is unimportant as the majority of load mitigation and speed control occurs during the first 10 seconds of the EFC event.

In addition, FIG. 3 illustrates how a variable pitch rate curve 156 corresponds to a capacitor voltage curve 158 of the energy storage unit 112. Capacitors have a much wider operational voltage range during emergency feathering conditions. For the same voltage, for example, 350 VDC at the start of the EFC, the capacitors will discharge down to 125 VDC by the time the blades reach their feathered position. Since this voltage is going down substantially at an R/C time constant rate, the pitch rate itself can come down during this discharge in order to lower the amount of capacitance required for this EFC event. This allows for the capacitor size to be lowered and may reduce the loading on the turbine during an EFC event, especially those loads that appear on the blades as they are quickly unloaded during the event. A constant pitch rate curve 160 is also shown for comparison where the pitch rate is five degrees per second the voltage stays constant at about 250V.

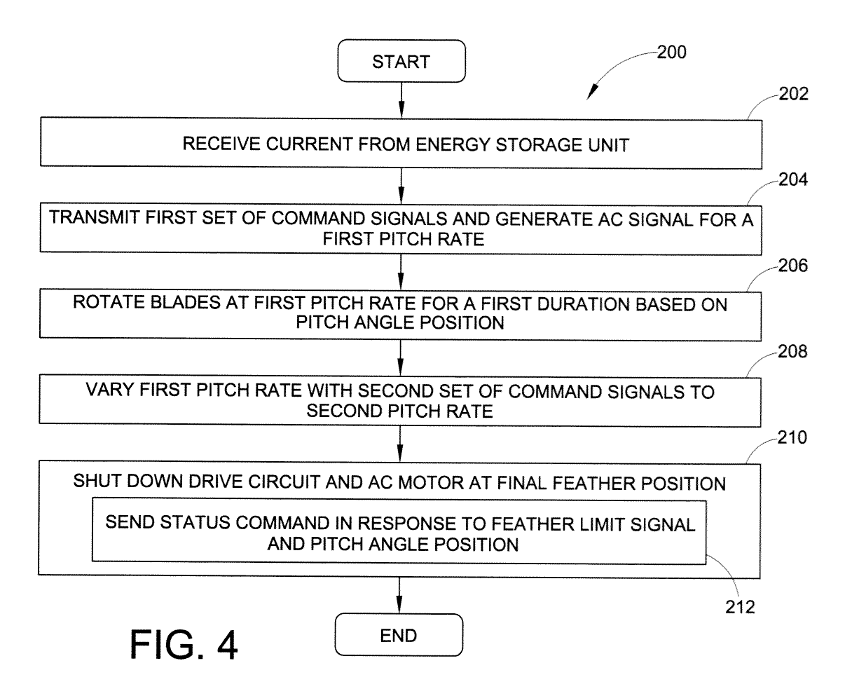

With reference now to FIG. 4, an example methodology 200 for controlling an emergency feathering of wind turbine blades during an emergency power shut down of a wind turbine is there illustrated. While the method is illustrated and described below as a series of acts or events, it will be appreciated that the illustrated ordering of such acts or events is not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

The method 200 initiates at start, and at 202 a current from an energy storage device is received by a variable pitch rate controller 122 of a safety system 100. The safety system includes a safety circuit loop that initiates blade feathering independently of a turbine control unit (TCU) 106, which generally monitors and controls data relevant for securing and operating the wind turbine, and independently of a pitch control unit (PCU) or pitch system controller 108 that is controlled by the TCU 106. For example, once an emergency feathering condition occurs and a safety circuit loop is open, a signal is provided at a safety loop interface line 136 to a relay 110. Switches 102 and 104 change to connect the variable pitch control to the servo controller 116 in response, and thus, a servo controller 116 is provided commands via a variable pitch controller 122 instead of a pitch command controller 126, which is controlled by the pitch system controller 108.

The variable pitch rate controller 122 receives its voltage and current (power) from the energy storage unit 112. In one embodiment, the current received is a DC current where the energy storage device is a super capacitor and/or a battery that is coupled to and monitored by the variable pitch rate controller 122 via a DC bus input line 124. The capacitance required of the capacitor is less due to the variable pitch rate of the blades during emergency feathering. For example, the capacitance may be less than about ten farads.

At 204, a first set of command signals are transmitted to the servo amplifier 116 (e.g., a servo controller). In response to the first set of commands signals, an alternating current is generated by the amplifier 116 for an AC servo motor 114 to operate at a first pitch rate.

At 206, one or more wind turbine blades are rotated with the servo motor 114 at the first pitch rate for a first duration of time that is based on a pitch angle position. An operating pitch encoder 118, for example, monitors the pitch angle position of the blades and transmits the position to the variable pitch rate controller 122. The duration of time can be determined based on the initial angle position of the blades. In one embodiment, the first duration is about two to five seconds at the beginning of the emergency feathering depending upon the initial position of the blades.

At 208, the first pitch rate is varied with a second set of command signals to a second pitch rate based on a variable voltage signal input that is provided at the servo amplifier 116 and to the variable pitch rate controller 122. As the capacitor of the energy storage unit discharges at a discharge rate, the voltage provided to the servo amplifier 116 becomes less. In response, the variable pitch controller 122 provides pitch rate and acceleration commands to the servo amplifier 116, which, in turn, provides frequency and voltage signals to the servo motor 114 for an AC current and the blades to be rotated at a second pitch rate.

Multiple inputs are provided to the variable pitch rate controller 122 for determining the set of commands transmitted to the servo amplifier 116. In addition to the variable voltage signal provided by the capacitor, for example, a feather limit switch signal from the feather limit switch 132 and a pitch angle or blade angle position from the encoder 118 is also received by the variable pitch rate controller 122. Based on the inputs received, the variable pitch rate controller 122 determines the set of commands for the acceleration and pitch rate of blade feathering during an emergency power shut down of the wind turbine.

In one embodiment, the servo amplifier or servo drive circuit 116 and the servo motor 114 are shut down at 210 when the blades reach a final feathered position, or are at ninety degrees from a fully feathered position. At 212, the power shut down occurs via the variable pitch rate controller 122 sending commands with a status update 126 although this block may not be able to receive these commands due to internal failures that generated this EFC in the first place. The variable pitch rate controller 122 therefore prevents over pitching of the blades past the final feathered position in response to the feather limit switch signal and the blade position received. Other inputs may also be accounted for as well, as one of ordinary skill in the art can appreciate.

In one embodiment, the first and the second set of command signals comprise different acceleration and pitch rate commands transmitted to the servo amplifier at different time periods of the emergency feathering. In response, the servo amplifier drives the servo motor with an alternating current signal having a frequency and the variable voltage input signal to generate the first pitch rate and the second pitch rate. The first pitch rate is greater than the second pitch rate and the second pitch rate is greater than zero. For example, the first pitch rate can be about five to twelve degrees per second, and the second pitch rate can be about two to four degree per second.

In one embodiment, for example, a first duration of the first pitch is about one to five seconds from the beginning of the emergency feathering procedure, and the second duration is about ten to fifteen seconds. The second duration initiates at about ten to twelve seconds into the emergency feathering. The emergency feathering occurs for a total duration of about fifteen to twenty-two seconds, for example. It should be appreciated that other embodiments can also be envisioned.

Although the disclosure has been shown and described with respect to one or more implementations, equivalent alterations and modifications will occur to others skilled in the art upon the reading and understanding of this specification and the annexed drawings. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention. In addition, while a particular feature of the invention may have been disclosed with respect to only one of several implementations, such feature may be combined with one or more other features of the other implementations as may be desired and advantageous for any given or particular application. Furthermore, to the extent that the terms “including”, “includes”, “having”, “has”, “with”, or variants thereof are used in either the detailed description or the claims, such terms are intended to be inclusive in a manner similar to the term “comprising”.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art. It is intended to include all such modifications, variations or improvements insofar as they come within the scope of the appended claims or the equivalents thereof.

What is claimed is:

1. A safety system for controlling an emergency feathering of blades during an emergency power shut down of an energy producing device, the system comprising:
an energy storage unit including an energy storage capacity for operating the safety system independently of a control unit during the emergency power shut down of the device;
a servo motor operatively connected to a servo drive circuit supplied with power from the energy storage unit for rotating the blades;
a variable pitch rate controller coupled to the energy storage unit and the servo drive circuit that is configured to vary a pitch rate of the blades from a first pitch rate to a second pitch rate based on a blade angle position of the blades during the emergency feathering with the servo motor,
wherein the variable pitch rate controller is configured to provide variable pitch rate commands to the servo drive circuit, and wherein the servo drive circuit and the energy storage unit are configured to provide a first set of motor signals and a second set of motor signals to the motor corresponding to the first pitch rate and the second pitch rate commands respectively and a discharge rate of the energy storage unit.

2. The system of claim 1, wherein the energy producing device comprises a wind turbine.

3. The system of claim 2, further comprising:
an operating pitch encoder configured to determine the blade angle position during the emergency feathering, wherein the variable pitch rate controller is configured to receive the blade angle position and a feather limit switch signal from a feather limit switch indicating a final feathering position of the blades.

4. The system of claim 2, wherein the variable pitch rate commands include the first pitch rate that is about five to twelve degrees per second and an initial duration for the first pitch rate that is a number of seconds in which the turbine no longer generates a power output, wherein the number of seconds comprises about one to five seconds when the blades are pitched at a zero degree initial position or less if the blades are pitched greater than the zero degree initial position.

5. The system of claim 2, wherein the servo drive circuit comprises a servo amplifier for converting a DC current transmitted by the energy storage unit into an AC current to operate the servo motor at variable speeds in response to the variable pitch rate commands and acceleration commands from the variable pitch rate controller, and wherein the energy capacity of the energy storage unit is less than about ten farads.

6. The system of claim 2, wherein the first pitch rate is a maximum pitch rate during a first one to three seconds of feathering depending upon an initial pitch angle of the blades, and the second pitch rate is a fixed pitch rate at about ten to fifteen seconds into the feathering that is less than the first pitch rate and greater than zero.

7. The system of claim 2, wherein the energy storage unit comprises a DC storage unit and the servo motor comprises an AC servo motor configured to operate at a variable rate that is proportional to an amount of voltage provided by the energy storage unit.

8. The system of claim 7, wherein the variable pitch rate controller provides a digital signal to the servo amplifier for determining the first pitch rate and the second pitch rate, wherein the first pitch rate is provided during the first five to fifteen seconds of the emergency feathering and the second pitch rate is about 3 degrees per second.

9. The system of claim 2, wherein the energy storage unit includes a super capacitor that provides a DC current to the servo drive circuit for powering the servo motor with an AC current.

10. The system of claim 3, wherein the variable pitch rate controller provides the first pitch rate and the second pitch rate commands that are proportional to the energy storage capacity of the energy storage system, and powers off the servo drive circuit and the servo motor that has an alternating current AC servo motor when a final feathering position is reached based on the blade angle position and the feather limit switch signal received.

11. The system of claim 2, further comprising:
a feather limit switch configured to signal to the pitch rate controller when a final feathering position has been reached by the blades, wherein the pitch rate controller is configured to shut power off to the servo drive circuit and the motor in response to the signal from the feather limit switch and a position of the blades.

12. A method of controlling an emergency feathering of blades during an emergency power shut down of an energy producing device with a safety system, the method comprising:
receiving a current from an energy storage unit at a variable pitch rate controller in the safety system having a safety circuit loop that initiates blade feathering independently of a control unit and a pitch system control;
transmitting a first set of command signals from a variable pitch rate controller to a servo amplifier and generating in response to the first set of command signals an alternating current signal for an AC servo motor to operate at a first pitch rate;
rotating one or more blades with the servo motor at the first pitch rate for a first duration of time that is based on a pitch angle position during the emergency feathering; and
varying the first pitch rate of the blades with a second set of command signals from the pitch rate controller from the first pitch rate to a second pitch rate based on a variable voltage signal input for a second duration of time.

13. The system of claim 12, wherein the energy producing device comprises a wind turbine.

14. The method of claim 13, wherein the first and the second set of command signals comprise different acceleration and pitch rate commands transmitted to the servo amplifier at different time periods of the emergency feathering, wherein the servo amplifier drives the servo motor with an alternating current signal having a frequency and the variable voltage input signal to generate the first pitch rate and the second pitch rate, where the first pitch rate is greater than the second pitch rate, which is greater than zero.

15. The method of claim 13, wherein the first duration is about two to five seconds at the beginning of the emergency feathering, the first pitch rate is about five to twelve degrees per second, the second duration is about ten to twelve seconds that initiates at about ten to twelve seconds into the emergency feathering, and the second pitch rate is about two to four degrees per second, wherein the emergency feathering occurs for a total duration of about fifteen to twenty-two seconds.

16. The method of claim 13, further comprising:
receiving at the variable pitch rate controller the pitch angle position during the emergency feathering of the blades in the emergency power shut down by an operating pitch encoder; and
shutting down the servo drive circuit and the AC servo motor when a final feather position of the turbine blades is reached.

17. The method of claim 16, further comprising:
receiving at the pitch rate controller a feather limit switch signal from a feather limit switch when the final feathering position that is about ninety degrees has been reached by the blades; and
wherein shutting down includes sending a status command in response to the feather limit switch signal and the pitch angle position from the encoder.

18. The method of claim 12, wherein the variable voltage input signal corresponds to a discharge rate of the energy storage unit.

19. The method of claim 12, wherein the energy storage unit comprises a super capacitor with a capacitance of less than about ten farads.

20. A safety system for varying a pitch angle of blades of an energy producing device during an emergency power shut down for an emergency feathering, comprising:
at least two variable pitch rate controllers that each comprise programmable logic devices and/or operational amplifiers configured to transmit variable pitch rate commands and acceleration commands to a respective servo amplifier based on a position of corresponding blades and a status of a feather limit switch;
a capacitor that stores back up power to operate the safety system independently of a controller and a pitch rate controller of the energy producing device, wherein the capacitor is operatively connected to the respective servo amplifier during the emergency feathering for an emergency power shut down of the turbine;
at least two servo motors that receive frequency and variable voltage signal inputs from the servo amplifier in response to the commands from the variable pitch rate controller to rotate the blades at a first pitch rate and a second pitch rate that is less than the first pitch rate and greater than zero.

21. The system of claim 20, wherein the energy producing device comprises a wind turbine.

22. The system of claim 21, wherein the servo amplifier generates an AC current from a DC current of the capacitor having a capacitance of less than about ten farads in response to the pitch rate commands and acceleration commands transmitted thereto.

23. The system of claim 21, wherein the AC servo motor operates at a variable rate that is proportional to the amount of voltage that is provided to the variable pitch rate controller by the energy storage unit.
